(19) United States
(12) Patent Application Publication
(10) Pub. No.: US 2024/0159309 A1
(43) Pub. Date: May 16, 2024

(54) GEAR TRANSMISSION DEVICE

(71) Applicant: Xinmin Xiao, Taizhou (CN)

(72) Inventor: Xinmin Xiao, Taizhou (CN)

(21) Appl. No.: 18/307,396

(22) Filed: Apr. 26, 2023

(30) Foreign Application Priority Data
Nov. 15, 2022 (CN) 2022230321444

(51) Int. Cl. F16H 57/08; F16H 1/46; F16H 57/023

(52) U.S. Cl. CPC F16H 57/082; F16H 1/46; F16H 57/023; F16H 2001/289

(57) ABSTRACT

A gear transmission device: comprising a main shaft A, a main shaft B and gear housing frames, the main shaft A and main shaft B are coaxial, the main shaft A is fixedly provided with the center gear A, and the main shaft B is fixedly provided with the center gear B; gear housing frames are connected with the main shaft A and main shaft B through bearings, gear housing frames comprise the fixedly connected housing frame A and housing frame B, the housing frame A is provided with several rotatable planetary gears A, and the housing frame B is provided with several rotatable planetary gears B, the planetary gears A mesh with the center gear A, and the planetary gears B mesh with the center gear B; several planetary gears A mesh with the internal gear A, and several planetary gears B mesh with the internal gear B.

### 1. TECHNICAL FIELD

The invention relates to the technical field of gear transmission devices, in particular to a gear transmission device.

### 2. BACKGROUND ART

The application of planetary gear transmission has a history of decades in China, because the planetary transmission changes the fixed-shaft gear transmission to the dynamic-shaft gear transmission, it adopts multiple planetary gears to share the load to realize power splitting and reasonably adopts internal meshing transmission and planet carrier, which has the advantages of small size, large transmission ratio, and large carrying capacity, widely used in various industries.

There are mainly two types of planetary gear structures currently on the market: 2K (NGW) and 3K (NGWN); the 2K (NGW) planetary gear transmission mode has two center gears and a planetary carrier assembled with 2 to 6 sets of planetary gears to form a closed-loop movement, that is, the sun gear is input, the internal gear is fixed, and the planetary carrier is output; the 3K (NGWN) planetary gear transmission mode has three center gears and a planet carrier assembled with 2 to 6 sets of double planetary gears to form a closed-loop movement, that is, one sun gear is input, one internal gear is fixed, and one internal gear is output; its speed ratio is larger than that of the 2K (NCW) type, the disadvantage is that it is difficult to process and manufacture, and the assembly requirements are complicated, it is difficult for the speed ratio to meet higher requirements.

The invention is obtained by further improving the structure of the 3K (NGWN) planetary gear.

### 3. SUMMARY OF THE INVENTION

The technical problem to be solved by the invention is to overcome the defect of the above technology and provide a gear transmission device.

In order to solve the above technical problems, the invention provides a gear transmission device: comprising a main shaft A, a main shaft B and gear housing frames, the main shaft A and main shaft B are coaxial, the main shaft A is fixedly provided with the center gear A, and the main shaft B is fixedly provided with the center gear B;

The gear housing frames are connected with the main shaft A and main shaft B through bearings, the gear housing frames comprise the fixedly connected housing frame A and housing frame B, the housing frame A is provided with several rotatable planetary gears A, and the housing frame B is provided with several rotatable planetary gears B, the planetary gears A mesh with the center gear A, and the planetary gears B mesh with the center gear B;

Several planetary gears A mesh with the internal gear A, and several planetary gears B mesh with the internal gear B.

As an improvement, the number of planetary gears A is five, and the number of planetary gears B is four.

As an improvement, two ends of the gear housing frames are provided with bearing sleeves.

As an improvement, both the internal gear A and the internal gear B are provided with a circle of several through holes.

As an improvement, the internal gear A is larger than the internal gear B, the center gear A is bigger than the center gear B, and the planetary gears A are bigger than the planetary gears B.

Compared with the prior art, the invention has the following advantages: compared with similar products, on the basis of the same speed ratio and the same carrying capacity, it is small in size and low in cost. Processing and assembly are less difficult. No special additional equipment is required, generally NGW planets can be produced. The gear transmission device of the invention has multiple transmission modes, large speed ratio, and large carrying capacity, which has high practical value and promotion value.

### 4. BRIEF DESCRIPTION OF ACCOMPANY DRAWINGS

FIG. 1 is a schematic diagram of a gear transmission device of the invention.

FIG. 2 is a side view of a gear transmission device of the invention.

FIG. 3 is a sectional view of a gear transmission device of the invention.

FIG. 4 is a schematic diagram of a gear transmission device of the invention without the internal gear A and 10 internal gear B.

FIG. 5 is a schematic diagram of the gear housing frames of a gear transmission device of the invention.

FIG. 6 is a schematic diagram of the main shaft A and the main shaft B of a gear transmission device of the invention.

As shown in the accompanying drawings: 1 main shaft A, 2 main shaft B, 3 center gear A, 4 center gear B, 5 housing frame A, 6 housing frame B, 7 planetary gear A, 8 planetary gear B, 9 internal gear A, 10 internal gear B, 11 bearing sleeve, 12 through hole.

### 5. SPECIFIC EMBODIMENT OF THE INVENTION

A gear transmission device of the invention will be further described below in combination with the accompanying drawings.

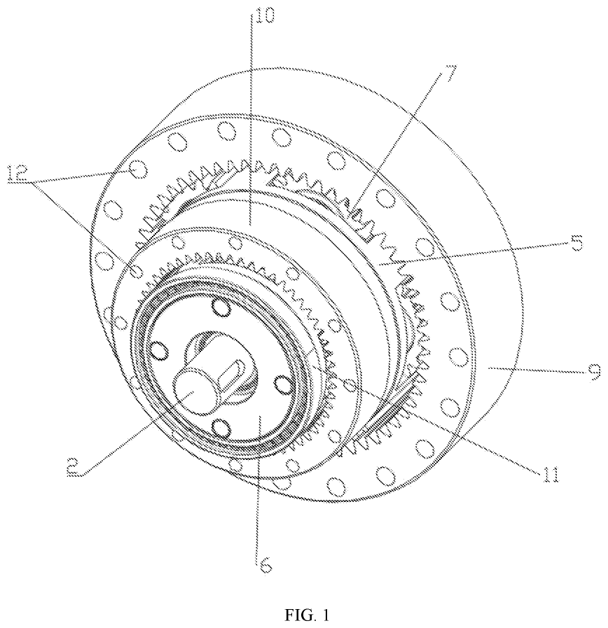

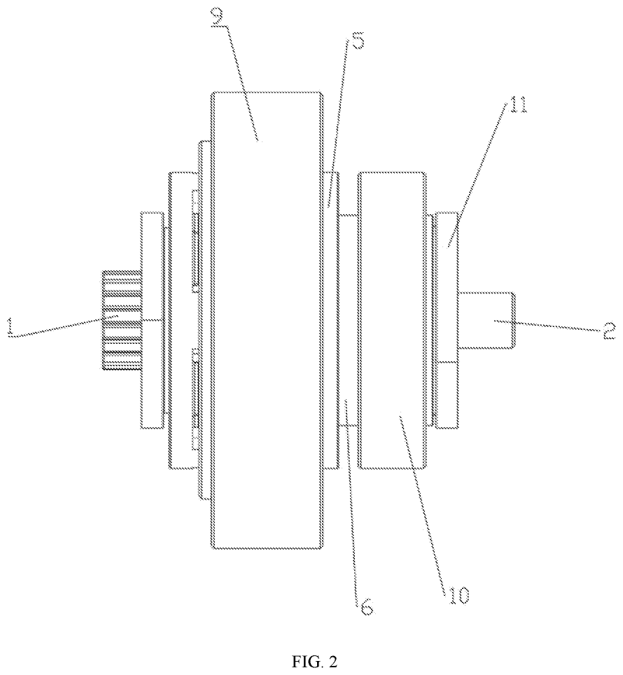

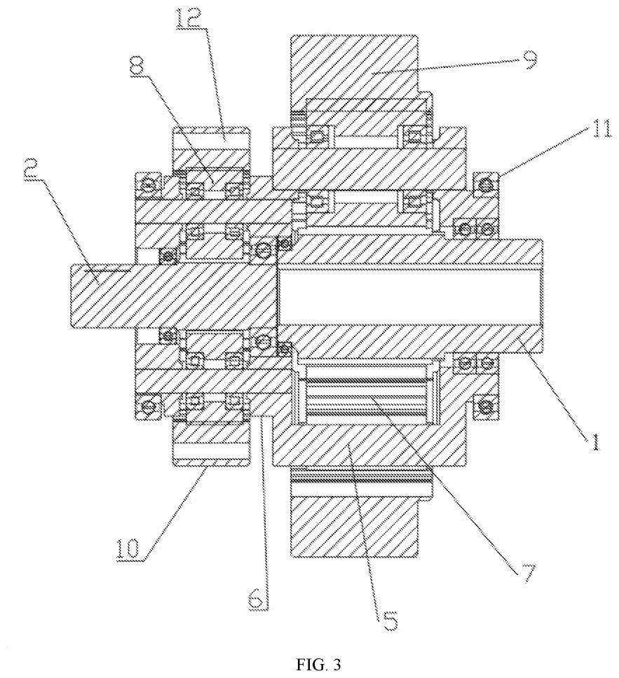

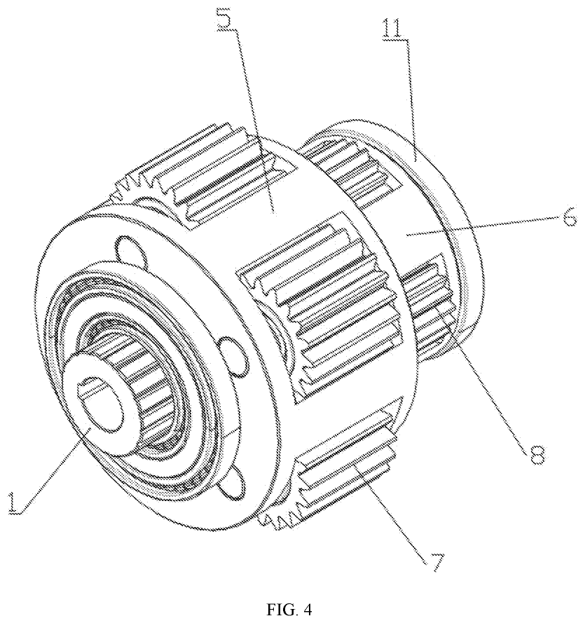

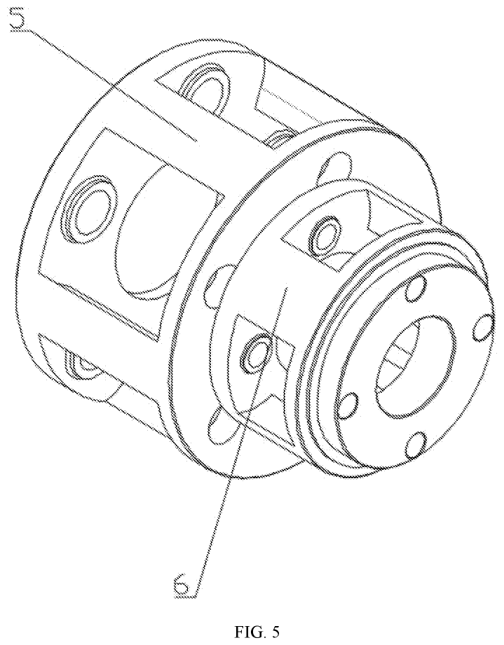

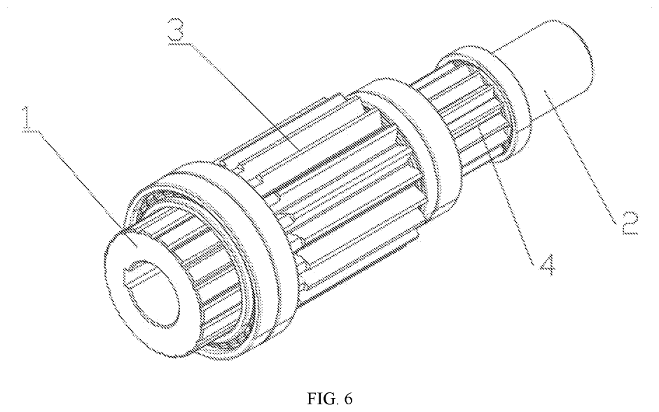

Combined with FIG. 1-FIG. 6, a gear transmission device: comprising a main shaft A1, a main shaft B2 and gear housing frames, the main shaft A1 and main shaft B2 are coaxial, the main shaft A1 is fixedly provided with the center gear A3, and the main shaft B2 is fixedly provided with the center gear B4;

The gear housing frames are connected with the main shaft A1 and main shaft B2 through bearings, the gear housing frames comprise the fixedly connected housing frame A5 and housing frame B6, the housing frame A5 is provided with several rotatable planetary gears A7, and the housing frame B6 is provided with several rotatable planetary gears B8, the planetary gears A7 mesh with the center gear A3, and the planetary gears B8 mesh with the center gear B4;

Several planetary gears A7 mesh with the internal gear A9, and several planetary gears B8 mesh with the internal gear B10.

The number of planetary gears A7 is five, and the number of planetary gears B8 is four.

Two ends of the gear housing frames are provided with bearing sleeves 11.

Both the internal gear A9 and the internal gear B10 are provided with a circle of several through holes 12.

The internal gear A9 is larger than the internal gear B10, the center gear A3 is bigger than the center gear B4, and the planetary gears A7 are bigger than the planetary gears B8.

When the invention is implemented, there are various transmission methods:
1. The internal gear B is fixed, the center gear A and center gear B are input, and the internal gear A is output;
2. The internal gear B and the center gear A are fixed, the center gear B is input, and the internal gear A is output;
3. The center gear A and center gear B are fixed, the internal gear B is input, and the internal gear A is output;
4. The center gear B and the center gear A are fixed, the internal gear B is input, and the internal gear A is output;
5. The center gear B is fixed, the internal gear B and the center gear A are input, and the internal gear A is output;
6. The internal gear B and the internal gear A are fixed, the center gear B is input, and the center gear A is output.

In the large reduction, the internal gear B is fixed, the center gear B and center gear A are input, and the internal gear A is output, for example:
(1) the center gear B=21, the internal gear B=59, the planetary gear B=19, the center gear A=21, the planetary gear A=19, the internal gear A=63 (the center gear B, the center gear A running at the same speed and in the same direction) the output speed ratio is 60;
(2) the center gear B=21, the internal gear B=60, the planetary gear B=19, the center gear A=21, the planetary gear A=19, the internal gear A=63 (the center gear B, the center gear A running at the same speed and in the same direction) the output speed ratio is 88;
(3) the center gear B=17, the internal gear B=64, the planetary gear B=21, the center gear A=17, the planetary gear A=22, the internal gear A=63 (the center gear B, the center gear A running at the same speed and in the same direction) the output speed ratio is 299.3;
(4) the center gear B=16, the internal gear B=74, the planetary gear B=28, the center gear A=17, the planetary gear A=30, the internal gear A=79 (the center gear B, the center gear A running at the same speed and in the same direction) the output speed ratio is 1188.168;

It can be widely used in various fields of planetary transmission reducer with large speed ratio, small size, and large load-bearing capacity, such as mining machinery, construction machinery, winch, hoisting machinery, rotary machinery, mixing machinery, mobile machinery, hoists, conveyors, crushers; it can also improve the design of the existing standard planetary reducer to improve its performance.

The invention and its embodiments are described above, this description is not restrictive, and what is shown in the accompanying drawing is only one of the embodiments of the invention, and the actual structure is not limited to this. All in all, if those skilled in the art receives its enlightenment, without deviating from the object of the invention, and without creatively designing structures and embodiments similar to the technical scheme of the invention shall fall within the protection scope of the invention.

1. A gear transmission device: comprising a main shaft A (1), a main shaft B (2) and gear housing frames, the main shaft A (1) and main shaft B (2) are coaxial, the main shaft A (1) is fixedly provided with the center gear A (3), and the main shaft B (2) is fixedly provided with the center gear B (4);
the gear housing frames are connected with the main shaft A (1) and main shaft B (2) through bearings, the gear housing frames comprise the fixedly connected housing frame A (5) and housing frame B (6), the housing frame A (5) is provided with several rotatable planetary gears A (7), and the housing frame B (6) is provided with several rotatable planetary gears B (8), the planetary gears A (7) mesh with the center gear A (3), and the planetary gears B (8) mesh with the center gear B (4);
several planetary gears A (7) mesh with the internal gear A (9), and several planetary gears B (8) mesh with the internal gear B (10).

2. The gear transmission device of claim 1, the number of planetary gears A (7) is five, and the number of planetary gears B (8) is four.

3. The gear transmission device of claim 1, two ends of the gear housing frames are provided with bearing sleeves (11).

4. The gear transmission device of claim 2, both the internal gear A (9) and the internal gear B (10) are provided with a circle of several through holes (12).

5. The gear transmission device of claim 2, the internal gear A (9) is larger than the internal gear B (10), the center gear A (3) is bigger than the center gear B (4), and the planetary gears A (7) are bigger than the planetary gears B (8).
